(19) United States
(12) Patent Application Publication
(10) Pub. No.: US 2016/0117790 A1
(43) Pub. Date: Apr. 28, 2016

(54) REVERSE TRANSFER SYSTEM AND METHOD

(71) Applicant: National Student Clearinghouse, Herndon, VA (US)

(72) Inventors: Douglas R. Falk, Haymarket, VA (US); Robert A. Romano, Herndon, VA (US); Lydia Lam, Ashburn, VA (US); Vanessa Brown, Manassas, VA (US); Steven Truesdale, Round Hill, VA (US); Manish Ganotra, Ashburn, VA (US); Ravi Batchu, Sterling, VA (US); Lan Qian, Potomac Falls, VA (US); William Pelham, Sterling, VA (US)

(21) Appl. No.: 14/793,274

(22) Filed: Jul. 7, 2015

Related U.S. Application Data
(60) Provisional application No. 62/139,353, filed on Mar. 27, 2015.
(60) Provisional application No. 62/067,211, filed on Oct. 22, 2014.

(51) Int. Cl. G06Q 50/20; G06Q 10/10

(52) U.S. Cl. CPC G06Q 50/2053; G06Q 10/10

(57) ABSTRACT

A computer system linking two-year degree granting institutions (DGI's) with four-year host institutions and with a nationalized database and unified server environment that is designed to communicate with individual students. The participating DGI and host institution must first obtain each student's permission for the system's use of their data. As part of the RT system, students will also be given access to their educational records housed at a centralized data repository. The reverse transfer process implemented by the system will include, for the host school, a file intake process involving the steps of receiving a file via FTPS, performing file edits, and correction of file errors. Once corrected, the host school will approve the file and submit it via a user Interface where the file will then be merged into the centralized database. For that student, the system will then reference a pre-stored authorization matrix in order to identify which DGI's are authorized to view the host school data.

### CROSS REFERENCE TO RELATED APPLICATIONS

This application claims the benefit of U.S. Provisional Application No. 62/139,353, filed Mar. 27, 2015 and U.S. Provisional Application Ser. No. 62/067,211, filed Oct. 22, 2014, the entireties of which are incorporated herein by reference.

### FIELD OF THE INVENTION

The present invention relates to computer systems and computerized processes for providing automatic reverse transfer credits for students from different educational institutions.

### BACKGROUND OF THE INVENTION

In higher education there is an increased emphasis on creating coordination and partnerships between institutions and the increasing number of successful post-secondary graduates. One of these initiatives is aimed at expanding and improving programs that award students two-year associate's degrees. Transfer students constitute a sub-population of students who may not receive the full benefit of a two-year associate's degree from a degree granting institution (“DGI”), such as a community college even though they may have completed the requirements for their associate's degree while pursuing a bachelor's degree at a four-year institution (“Host”). An existing institutional process involved in awarding associate's degree credits is referred to as “reverse transfer.” (“RT”). Typically, RT processes involve individual agreements between individual DGI's and the Hosts to meet the goal of maximizing RT credits between those institutions.

Reverse transfer can provide important benefits. In a recent study “Credit When It's Due” published by the National Student Clearinghouse (October 2013), it was found that 78% of students transfer from a two-year institution to a four-year institution without receiving an associate's degree. Meanwhile, the reported data also shows that students who transfer to a four-year institution after having received an associate's degree, are more likely to complete a four-year degree—72%, compared to 56% who do not. This 16% difference can, in part, be explained by the confidence instilled in those students who have received a diploma “along the way” towards a four-year college degree. Moreover, approximately thirty States have adopted policies promoting reverse transfer, the culmination of which is more direct grant money based on a DGI's higher graduation rate.

While systems designed to facilitate reverse transfer thus makes sense, improved technology can also be a potential barrier to the overall effectiveness of an RT program. One barrier relates to creating inefficient or ineffective educational silos. To the extent each State builds its own technical capacity to engender a reverse transfer process, it also creates a system that is isolated from that of other States or jurisdictions making it potentially more difficult for those students who transfer into or out of a given State. And a significant number of students are potentially impacted by this drawback. An initial analysis of the number of students in 2013 who attended more than one institution across state lines yielded approximately 800,000 potential “completers”. A second drawback to some technology bound RT processes relates to their lack of flexibility. Specifically, certain systems do not allow students to receive credentials for things other than two year college degrees, such as certificates, and micro-credentials. A third drawback, is that the RT process can cost time and money if not efficiently implemented through technology. As a consequence, there is a built-in disincentive for a Host institution to commit such resources, than a DGI in a State that provides direct grant awards to the DGI having higher reported graduation rates.

Another consideration is the impact of the Family Educational Rights and Privacy Act (“FERPA”) on RT data. In order to be FERPA-compliant, an ideal system must ensure that there is student permission for use of their data and each institution must indicate that each student has provided permission.

A final consideration is that RT relies on the existence of underlying articulation contracts between participating Host institutions and DGI's. There is a need for a system that is flexible enough to accommodate the differences between the terms of these agreements and also ensures that participating institutions have existing agreements in place with one another. Ultimately, there is also a need for a system that includes a uniform articulation agreement the terms of which must be accepted by each institution in order for it to participate.

Although certain technological approaches have made inroads and provided offerings for RT processes that exhibit some of the desired characteristics, none have offered a technologically streamlined approach that is fully FERPA-compliant, integrated within a national system (by leveraging existing infrastructures) and designed to maximize efficiency through optimized process design, hardware architecture and efficient software processing.

### SUMMARY OF THE INVENTION

For these and other reasons, the present invention comprises a computer system linking two-year DGI's with Host institutions and with a nationalized database and unified server environment that is designed to communicate with individual students.

The participating Host institution must first ensure each student's permission for the system's use of their data. As part of the RT process, students will also be given access to their educational records housed at a centralized data repository. The RT process will include, for the host school, a file intake process involving the steps of receiving a file from the Host via FTP, performing file edits, and correcting file errors. Once the file is corrected, the Host will approve the file and a notification will be sent to the appropriate DGI that course information has been uploaded. Submission can be via a system-to-system interaction, through a web Interface, or through some other known means that is well known in the art (“Interface”). Once submitted the file will be merged into a centralized database. For that student, the system will then reference a pre-stored authorization matrix in order to identify which DGI's are authorized to view the host school data.

The RT database is designed to be centralized and available on a national basis. The centralized database can also grow to support a national course exchange platform outside of RT.

The two year DGI file intake process involves retrieving course information provided by a corresponding Host institution. This can happen in two methods: push mechanism once the Host sends course information for the associated active DGI; or DGI making a request for specific course information. In both cases, the pushed course information or the requested course information will be available for DGI to download via a secure file transfer protocol (“FTPS”) or via another similar Interface. The DGI request file will contain the students, and their associated identifier information, along with course and grade information in order to determine degree eligibility. These candidates can include those who have potential for earning an associate degrees. This data will be pulled from the centralized RT database/server utilizing the matching process to ensure security of student data.

In the push method introduced in the above paragraph, matching is performed based on the school identifier that matches the DGI to the Host's course/student information. In the request method, the matching processing involves connecting students in the request file to information contained in the RT database. Once a match is found, an authorization matrix is created to determine which two year DOI can view the Host school data. This could be based on a network setup or could be those schools designated in the intake file from the Host. Once a match is made, a response file is created listing all of the student matches and associated course credit information. The completed file is then transmitted to the two year DOI via FTPS or any other file transfer technology known in the art.

Once DGI determines eligibility and acceptability of the course credit information, known as the DGI degree audit process, a degree data submission process is then entered. The DGI will submit the eligible associated degree due to RT process via a standard degree file intake process already established by the centralized system. In addition to degree elements required by the standard degree intake process, a new RT identifier will be sent by DGI acknowledging the student's degree was earned via the RT process. During this process, the degree with the RT identifier will be moved from Informix or another equivalent RDMS platform to the RT database. Reporting and auditing is then available, such as the number of degrees awarded due to RT and the correlation with the number of two-year DGI's that have accessed the database.

Personalization of the RT system is also critical in order to attract significant acceptance. An academic record datamart will house a student's grades and enrollment and degree information. Transactional data will also be available, such as which DOI had previously been sent student(s) and course(s) data. The data will be linked to the enrollment system and data that is currently stored at the centralized repository. This data will allow students (and institutions) to receive a holistic presentation of their data and create disputes against the data shown. The datamart will also enable those institutions to see data holistically and allow schools to fix their data. Most critically, the datamart will serve as a validation of the student's enrollment at the DGI and Host institution for an RT degree award. Current standard practices for obtaining and securing enrollment and degree data will also be utilized. As noted previously, the academic record datamart is also FERPA compliant.

To create the datamart, match and merge RT functions in connection with the central database must occur. The datamart record is then created. An extract/transform and load (“ETL”) process is further activated to move data between the centralized RT database, the main central data warehouse, and the academic record database. All log requests for the student's data are captured and tied to the datamart record.

A student portal is also used in the system. The portal serves as a primary access point for students to view all of their academic records housed at the central repository. Institutions may also access student data associated with that institution. Portal records include courses and grades, enrollment records and degree records. The portal includes a User Interface for a student comprising, for example, web pages with multi-browser support. Supported browsers can include, but not be limited to, conventionally known or used browsers such as Chrome, Safari, Firefox, Internet Explorer and Mobile Web. These supported browsers will support login registration to enable students to view their academic records. The user Interface also works with any mobile ecosystem platform, including but not limited to IOS, Android, Blackberry and Microsoft. The user Interface design will focus on the needs and tastes of the student demographic, and ensure that institutions have the ability to close disputes and submit modified data.

Accessibility to the student portal will be challenge-based where questions will be first posed in order to validate a student's identity (especially for first time access). Once access is allowed, students will be able to create and manage their profile including user-ids, passwords, and verification questions. Once registered, students can use the matching and search services allowing them to query and view their academic records (including but not limited to: courses/grades, enrollment and degree information). Students can also identify specific schools/institutions that have not sent the student course/grade data. Further, students can view when their records were accessed, and by whom. Finally, the portal will include a dispute workflow to allow students to interact with a school or institution regarding any issues or disputes with those student academic records housed in the academic record datamart. Corrections to the data, however, can only be made by the school.

A further feature of the RT Transfer system is the provision of a standardized web service Interface for schools to send/or receive requests via a student portal. The web service Interface will enable a two year DGI to receive real-time alerts when, for example, new student data has been delivered to the centralized database by a host institution. By using the portal web Interface, RT information can be utilized quickly and assessed to determine if a student qualifies for an RT degree from the two-year DOI.

The foregoing and other objects, features, aspects and advantages of the embodiments of the present invention will become more apparent from the drawings and detailed description provided below wherein like reference numerals refer to like elements.

### BRIEF DESCRIPTION OF THE DRAWINGS

FIG. 1 is a data flow diagram of the reverse transfer process forming a first embodiment of the present invention;

FIG. 2 is a hardware block diagram of the reverse transfer system;

FIG. 3 is a reverse transfer processing flow diagram relating to the file intake process;

FIG. 4 is a flow diagram of the flow validation error process for the reverse transfer system;

FIG. 5 is a flow diagram of the reports and request user Interface processes of the reverse transfer system;

FIG. 6 is a hardware block diagram of the reverser transfer deployment overview of the present invention;

FIG. 7 is a flow diagram of the course intake process 18 shown in FIG. 1; and

FIGS. 8-20 show screen shots of the Interfaces covering the different aspects of the preferred embodiments of the invention.

### DETAILED DESCRIPTION OF THE INVENTION

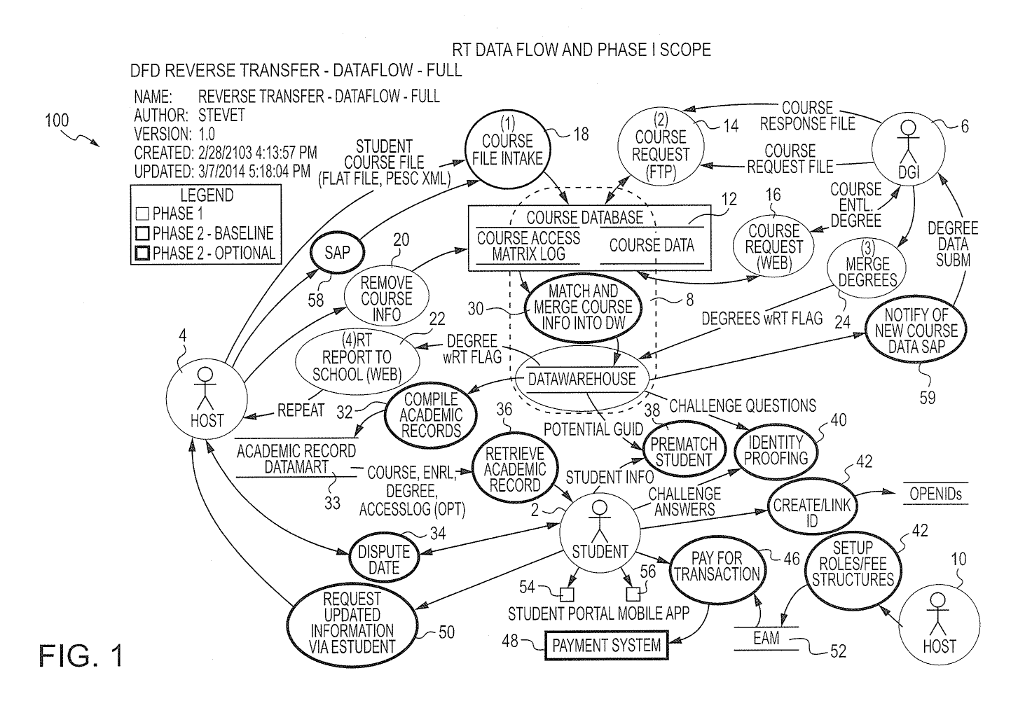

FIG. 1 is a data flow diagram of the reverse transfer process forming a first embodiment of the present invention. Specifically, the data flow for a full embodiment of the reverse transfer system 100 is shown. Data flows between several entities, including a Student 2, the provider or Host 4, the requesting or degree granting (DGI) school 6, the central data warehouse 8 and the central warehouse service entity 10.

The student effectively initiates the process by making the academic decision to transfer to the Host 4 from the DGI 6. Upon or prior to acceptance into the Host school, the Host 4 receives an official transcript from the DGI 6. The student's record for both schools now reflects the full name of the other institution, which can prompt a system determination whether or not an RT articulation agreement exists between those two institutions. The student has the option of opting into the RT program through many methods outside of the designed system. This opt-in process will be documented on both the Host and DGI. The designed system will know of the opt-in by the fact that course information has been sent by the Host who has a valid agreement with the warehouse service entity 10. The DGI will also be able to retrieve course information for opted in students by the fact that it will have a valid agreement with entity 10. The DGI School 6 will request course information from the course database 12 as either an FTPS 14 (or its equivalent) or as a web request 16. Meanwhile, the newly enrolled student 2 takes certain courses which are loaded in the course database via dataflow 18. Upon successful completion of a course, the course information is updated and that data is also sent to the course database 12 via dataflow 20. All course completion data is reported to database 12 and will be available for retrieval by the DGI by websites 14 and 16. Once the DGI 6 determines that enough credits have been earned, it will notify the central data warehouse 8 via dataflow 24 that the student has been awarded a degree. Similarly, a report is generated for the Host School 4 via dataflow 22.

In a second embodiment, dataflows 30-54 are shown.

Specifically, in the second embodiment, a centralized data warehouse 31 tied to each student 30 is provided with the course information from the case database 12. One purpose of the data warehouse 31 is to complete online academic records via dataflow 32 which are then supplied to a separate database or memory area known as the academic record datamart 33. Other features of the data warehouse 31 include a pre-match student function 38, and a challenge answer feature 40 which poses challenge questions 40 to the student at log-in. Function 38 includes requesting minimal information from the student in order to match against data stored in the warehouse 31. With this match, further challenge questions will be used to fully validate the match. Dataflow 42 in turn enables the student to create and manage an on-line profile 42. Further aspects of the student account include a data table or database containing set-up rules and fee structures which are developed and managed by the central data warehouse service organization 10. The fee structure also lends itself to the paid transactions dataflow 46 with the student and an enterprise asset management system 52 which provides the back-end support for all student transactions. A separate payment system 48 such as PayPal or other conventionally known or used payment platform, or a credit card processor, operates the transactions and provides appropriate payment reporting to the service provider 10.

In the second embodiment, the student can directly request updates and dispute data to their corresponding Host School 4 along data flow 50 and 34 respectively. Other features of the second embodiment include a portal response/acceptance function 58, a notification to the DGI 6 of a new course 59 that has been added to the data warehouse catalog 31 and mobile 56 and portal 54 apps that the student 2 can use to access the RT system 100.

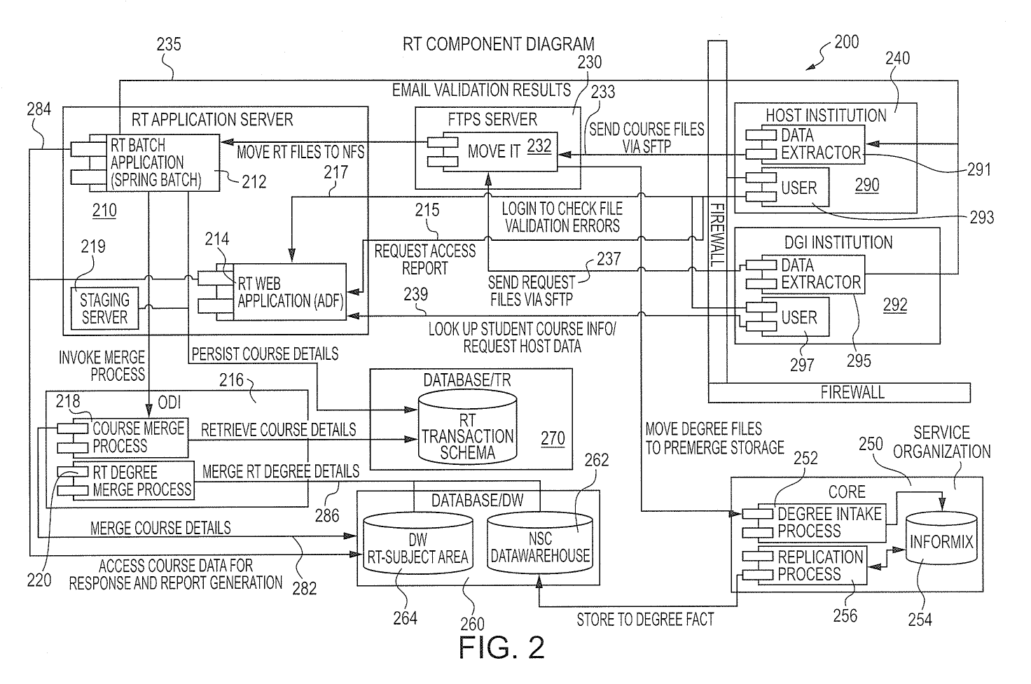

FIG. 2 illustrates a hardware block diagram of the reverse transfer components and system architecture 200. The system comprises an RT Application server 210 which communicates with various databases through processors (or virtual processors) 212 and 214 respectively handle reverse transfer batch applications (using, for example, Spring Batch Frameworks or other known batch processing technologies) and reverse transfer web applications. The RT Batch Application processor 212 invokes a merge process with, for example, a Oracle Data Integrator 216 or any other ETL product (“ETL”), which in turn separates the physical network layer from the network protocol layer. The RTL 216 includes two special function processors 220, each of which respectively process course and degree data from application server 216. The ETL 216 merge process will enable course information to be merged into a location that will provide for better matching and comprehensive view for the portal.

The secure file transfer protocol (“FTPS”) server 230 is used to transfer computer files to and from different hosts over a TCP-based network such as the Internet. In this embodiment, the FTPS server moves FTPS files from the host institution's server to the RT Application server 210.

The FTPS Server also transfers degree files to the central data storage 31 which incorporates a service organization server core 250. The core includes at least two specialized units and a database storage unit—each of which can form a distinct processor, or alternatively a virtual device. The first, a degree intake processor receives degree file information from the MoveIT processor 232 in the FTPS Server 230. The MoveIT processor 232 is an existing system that moves all external files into the service provider (10) firewall 294 safely and securely, and sorts appropriate files to specific application locations for consumption. The second, a replication processor 256 receives data from the Informix or other RDMS type database 254 and provides replicated data to the data warehouse 262 and the relational memory 254. The Informix database 254 stores all other degree and enrollment information that will be merged into the data warehouse 262 to enable a comprehensive view for the portal. Other forms database platforms other than Informix are considered to be part of the invention.

Other hardware in the central system include a reverse transfer data warehouse subject area mass memory storage device 264. This memory receives course merge details 282 from the ETL processor 218. The memory 264 provides and receives access course data 284 for response and report generation 210 in connection with the RT batch application (spring batch) 210 and Reverse Transfer web application 214 (ADF) servers or processes. Both data warehouse memories also store merged reverse transfer degree details 286 from both ETL processors 218, 220 (course merge and reverse transfer degree merge).

Server 290 for Host Institution 2 communicates with system 200 through firewall 240. Server 290 is designed to communicate directly with the reverse transfer application server 210 and the FTPS server 232. In the latter instance, the Host institution data extractor processor 291 sends course files to the FTPS server move IT processor 232 via SFTP 233 or its equivalent. Course information will be moved into the staging server 219 prior to validation. Course information will then be validated. Email communications concerning course data used in the reverse transfer process, such as email validation results 235, are communicated between the server system 290 and the RT batch application processor 212. The Host Institution 2 server system 290 also includes individual user computers, or user community server(s) 293 which communicate with the reverse transfer web application server 214 to request access reports, or to login to check file validation errors 217.

The DGI institution 6 server system 292 incorporates specialized or virtual processors 295 and 297 respectively which operate in a similar manner to those computers in the Host Institution 4. These processors can retrieve information via two methods described in paragraph [0011]. In the push method, data extractor device 295 will login to the FTPS server 232 and download the information. In the request method, the data extractor device 295 sends reverse transfer requests via SFTP 237 to the FTPS move IT Server 232. The user service/computer 297 is configured to link to the RT web application server 214 via link 239 in order to search for student course information and to request host institution data. User server/computer 297 can also login to check for file validation errors and for regeneration of download files via link 217.

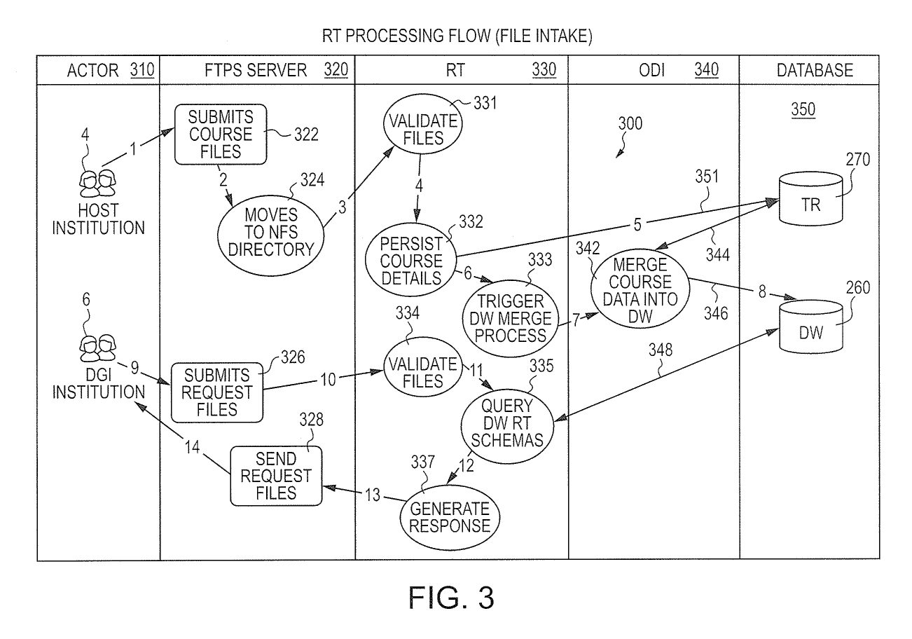

FIG. 3 illustrates the reverse transfer process flow for file intake 300. The process flow operates through five stages, the actor stage 310, the FTPS server stage 320, the reverse transfer processing stage 330, the ETL stage 340 which merges certain transferred files and the database storage stage 350 which includes those actions for the data warehouse 260 and the centralized transactions database 270 previously described in connection with FIG. 2.

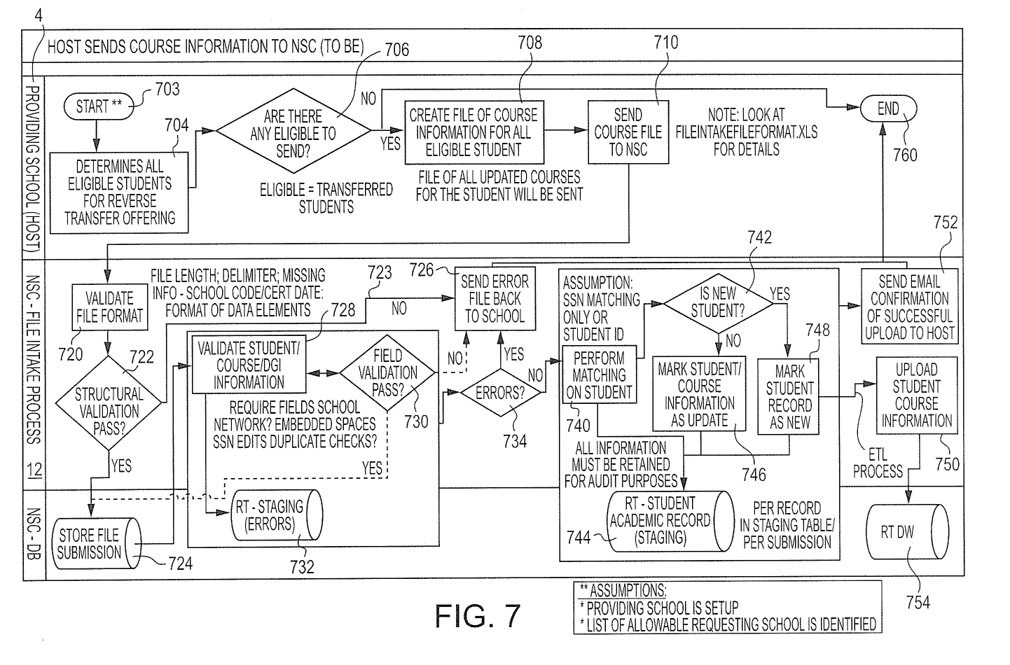

The file intake process 300 occurs as follows: At actor stage 310, the host institution will determine eligible students to submit. The host will extract the data and submit its course and grade files 322 to the FTPS Server 230 at stage 320. The submitted course and grade are then moved to the network file system directory 324. Files originating from directory 324 are then validated at step 331 and course details are created in temporary tables which are subsequently transferred to permanent tables and stored at step 332. Step 332 is known as a persist process, which will be described in more detail in connection with FIG. 7. The course details are then stored in relational files at step 351 in the transaction database 270. The persist course step 332 also triggers a data warehouse merge process which transfers the merged files to the ETL layer 340 where the definition of a course, the permission to that course, and the course information is identified. Course and grade information are integrated with other transactional data 344 and then stored in both databases 260 and 270 at steps 344 and 346 respectively.

File intake for the degree granting institution 6 starts with either a reverse transfer file request being sent to the FTPS server at step 326 or a simple download of a generated file based on Host provided information. If a request method is used, the request files will be validated through a reverse transfer process at step 334, and a data warehouse reverse transfer file query 335 is created using the reverse transfer database, such as, for example, an Oracle platform. Validation of files can include structural validations as well as required field elements, described in more detail in [0053]. Data is subsequently prepared at step 348 from data warehouse 260 and a response is generated at step 337. The relevant file is then sent to the degree granting institution 328 during the FTPS Server processing stage 320.

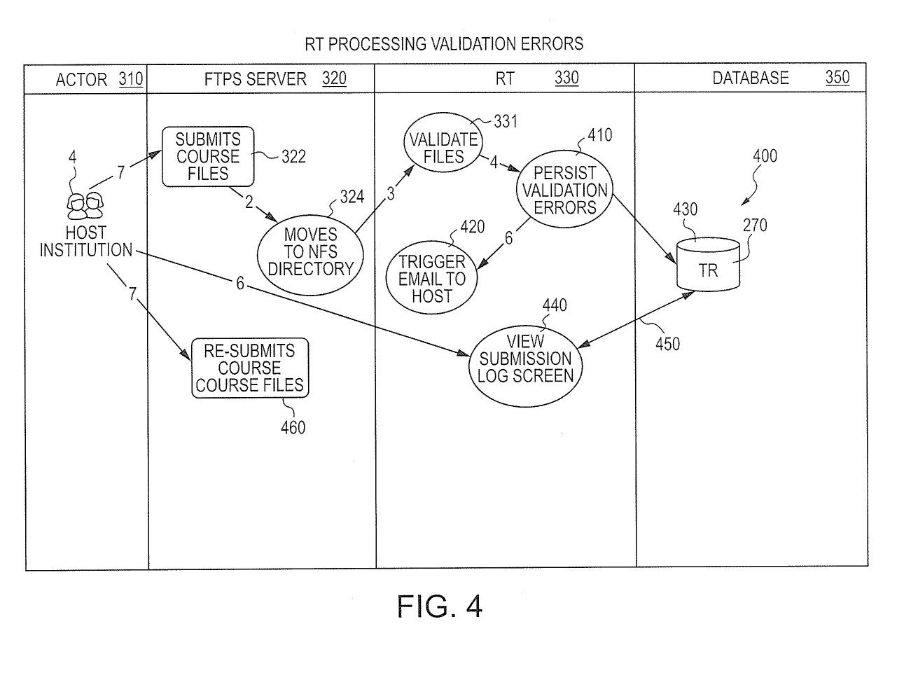

FIG. 4 illustrates the process flow for reverse transfer validation errors 400. As previously described in connection with in FIG. 3, the error validation flow begins by the Host institution 4 at actor stage 310 which submits course files 322 at the FTPS server stage 320 and moves those files to the network file system directory 324. The RT process flow 330 then validates the files 331 as described previously.

However, if a persist validation error 410 is detected, it will cause the reverse transfer process to send an email 420 to the Host institution 4. The persist validation error message is also sent to the transaction database 270 at step 430. Upon receipt of the error email 420, the Host institution 4 will review the error through the view submission log screen 440 at reverse transfer stage 330 which in turn receives the erroneous data from the transaction database 270 at step 450. As a consequence, the Host institution 4 can revise its course files and re-submit those files at step 460, where they are processed as previously described in connection with FIG. 3.

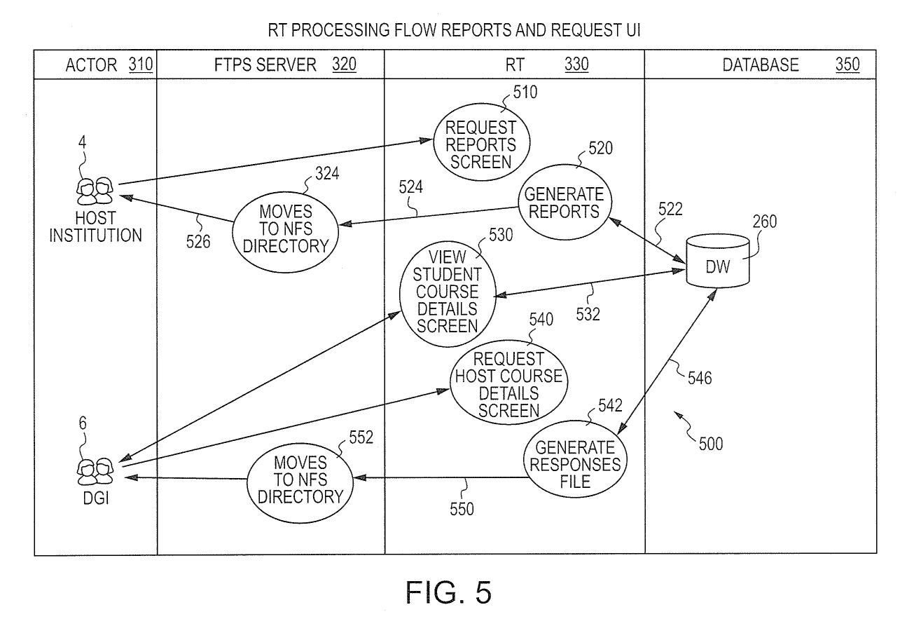

FIG. 5 discloses a process flow chart for the reverse transfer reports and requests from DGI's through the Interface (as defined in [0009]) concerning how it receives student data 500. As shown, the Host institution 4 requests the reports screen 510 at the reverse transfer stage 330. An RT report is then generated at step 520 after receiving data from the data warehouse 260 at step 522. Depending on the type of report requested and generated, some will be moved through the network file system (NFS) directory 324. The NFS directory is a central directory where incoming files moves data to. at the FTPS Server stage 320 whereupon it is provided to the requesting Host institution at step 526; or the report can be viewed online. The DGI will also have similar report generation capabilities.

For already generated course and grade files, DGI's 6 can login via step 532 to view prepared files and regenerate them if desired on the screen at system 530. The generated responses will be moved via SFTP 550 to the NFS directory 552.

The degree granting institution 6 can in turn receive a reverse transfer report for an identified student by viewing that student's course details screen which is derived from data stored in the data warehouse 260. Additionally, the degree granting institution 6 may request course details for more specific student inquiries at step 540, whereupon a response file is generated at step 542 based on data retrieved from the data warehouse at step 546. Once created, the file is sent to the network file system directory at 552, and on to the degree granting institution 6.

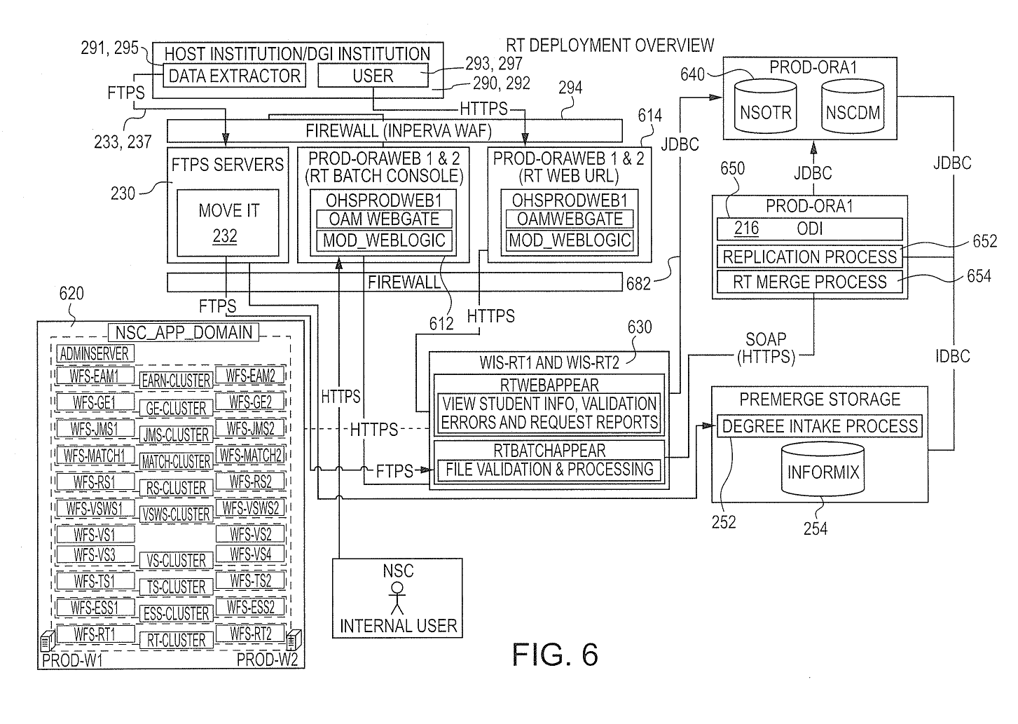

FIG. 6, is an overview block diagram that illustrates the RT hardware deployment overview of the centralized system and high level data flow between the computers 290 and 292 for the host and the degree granting institutions respectively (FIG. 2) located behind firewall 294 and the FTPS servers 230.

The FTPS Servers 230 are deployed inside firewall 610, 294 along with an RT batch console 612 and an RT Web Url Server 614. As previously described in FIG. 2, the data extractors 291 and 295, which are respectively located in the Host, and DGI institutions communicate and send secure file transfer protocol data relating to reverse transfer and course information to the FTPS Servers along communication links 233 and 237. SFTP (SSH File Transfer Protocol, or its functional equivalent as is known in the art) is used to support transport of files through links 233, 237 from which course files are transferred from the host data extractor 291 (in FIG. 2).

Additional modules that communicate with the FTPS Server, and consoles include the APP Domain 620 and the RT web and RT Batch App Units 630 which are enterprise archive servers that package one or more modules into a single archive so that deployment of the various modules into an application server, such as FTPS server 230, happen simultaneously.

The .ear modules in turn communicate with databases 640 NSCTR (Transaction Database) and NSCDM (Datamart Database) via link 632. Preferably data is transmitted in JDBC format since the databases 640 can include Java relational databases (JDBC is an API for the Java language that defines how a database is accessed). However, any other known relational format can be used. The RT Batch .ear processor also communicates with the ETL 216 in simple object access protocol (SOAP) which is designed to exchange structured information in the implementation of web services. In addition to data integration performed by the ETL core 216 comprising a replication processor 652 and an RT merge processor 654 integrate course detail and degree detail data. The results are stored in the database 640 along with degree intake process results in the premerge storage 252.

Referring to FIG. 7, a detailed flow 700 of the course intake process 18 (FIG. 1) is illustrated in greater detail. As set forth previously in connection with in FIG. 1, step 18 involves the Host institution 4 sending course information to the central RT processor 12.

The course file intake process 700 commences at Host institution 4 where the institution determines all eligible students for the RT offering 704. Once the list of students has been compiled, the system tests whether there are any eligible students to send 706. If the answer is affirmative, then the Host creates course information files for all of the eligible students 708 and sends the course files 710 to the RT processors 12 (as shown in FIG. 1). If no eligible students are found, then the intake process ends at step 760. If no file is to be generated by the Host, then no further correspondence with the DGI will occur.

Course file intake at the RT processor 12 begins at step 720 where the received file format is validated. Validation is broken into two sets of validations—structural and field level. Structural validations help to identify gaps in the provided file layout from the Host versus the designed and file layout detailed in the implementation guide. Field level validations will include checks against each data element provided in the course file from the Host to ensure integrity with the datamart 744. Once structural validation is passed, the file submission is recorded at step 724 to ensure traceability. If validation fails, errors will be sent back to the school at step 726. After the file is stored, field level validations (step 728) will be run against the stored raw data from step 724. The information to be validated include: student, course, and DGI accessibility information. Accessibility means the Host has designated a certain DGI 6 to be allowed to view the student's course and grade information once they have a signed agreement with the service provider 10, and the corresponding Host institutions 4 have provided course information for the DGI 6. When all validations have passed at steps 722 and 730, the process proceeds to matching (step 740) and storing the student and course records (step 744).

Details of the persist (referenced in FIG. 3, step 332) are broken up into three steps. Step 732 is about persisting into the staging environment of the system. This will include raw data storage and associated errors generated from step 728 (validation). The second step 744 is moving the data from the staging tables to the detail tables which enables prepping of the academic records for data warehouse consumption. The last step in the persist process is step 754 which moves the validated and scrubbed academic records into the data warehouse. Step 754 includes defining course existence, distinct course information, and the permission for DGI accessibility. Once step 754 is completed, course information will be made available for DGI request and consumption.

Step 740 matches up the validated student course file with information that may have been previously provided by the Host institution 4₌and focuses on the field level validations. Matching function 740 is performed by the RT server 12 on a student using social security or student ID criteria or other relevant student information. This matching process will allow the system to know if course information for a given student needs to be updated, inserted, or removed as denoted by steps 742, 746, and 748. The process of validating the entire course file will take place prior to communicating back to the Host institution 4₌of any errors. Once all uploaded data has been marked as updated or new; the ETL process runs to pull the data into the DW (steps 750 and 754). At the same time, an email confirmation will be sent to host institution stating that the file has been successfully uploaded (step 752).

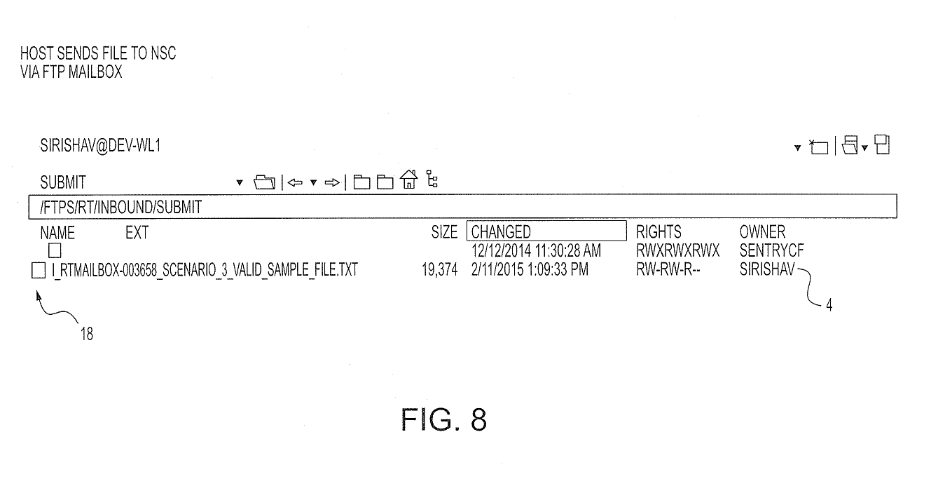

FIGS. 8-20 illustrate examples of the interface that can be used in connection with the present invention.

FIG. 8 illustrates an interface showing, from the perspective of the warehouse service entity 10, an update file 18 from Host 4 which is sent via an FTP mailbox.

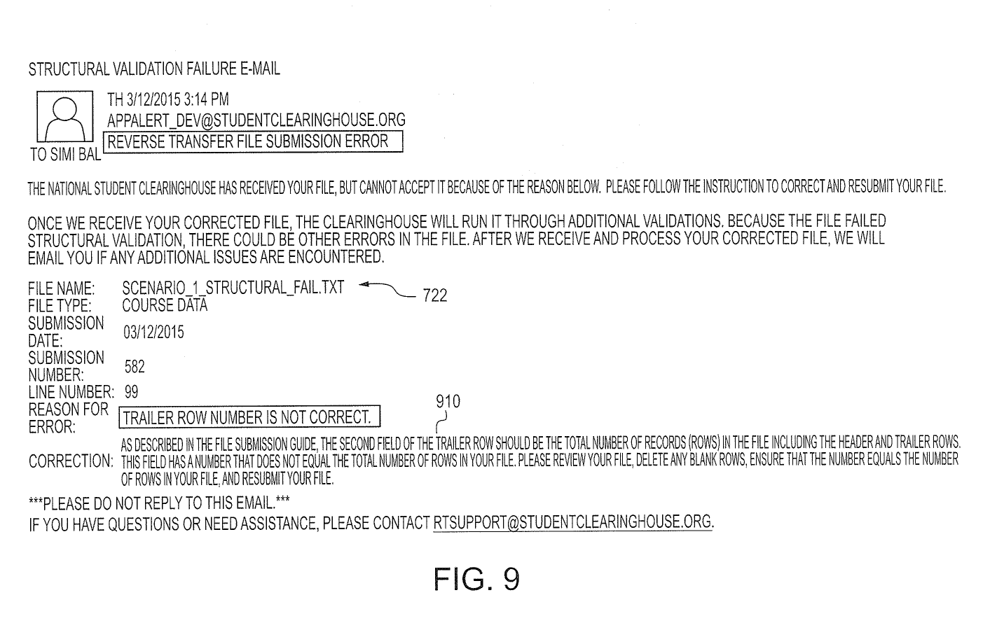

In FIG. 9 the course file 18 is first structurally validated by the service entity 10 at step 722 (FIG. 7). The service entity 10 informs the Host 4 that the uploaded course data second field of the trailer row should reflect the total number of records in the file 910. The structural validation makes this determination by comparing the number in the second field to the total number of rows in the Host's file. Preferably, all structural validations for course files are presented in this format.

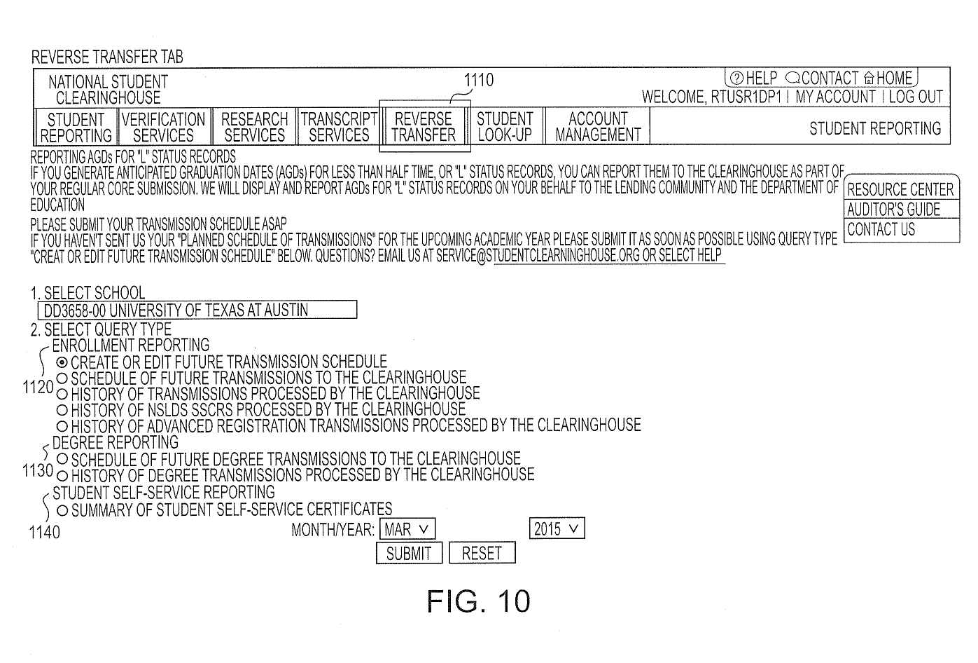

FIG. 10 shows an exemplified interface screen of the school landing page for the website reverse transfer tab 1110. The portion 1120 is the reporting tab for schools reporting on enrollment/degree information to what can be a Host or a DGI (see 18, FIG. 1). The degree reporting portion 1130 provides the DGI 6 with options covering degree transmissions by service entity 10. Schools can access tab 1110 to receive a summary of the student self-service certificates 1140.

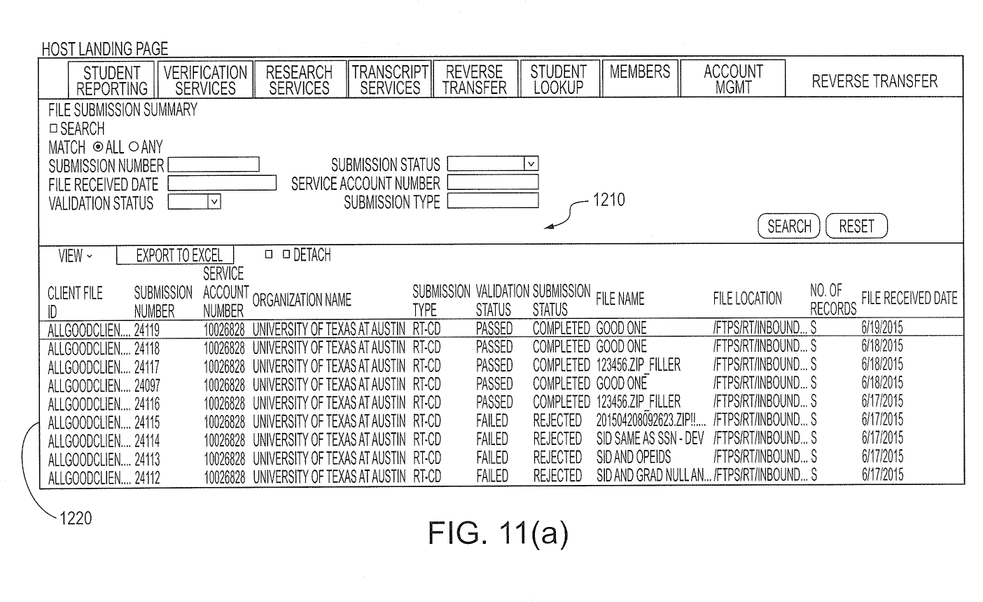

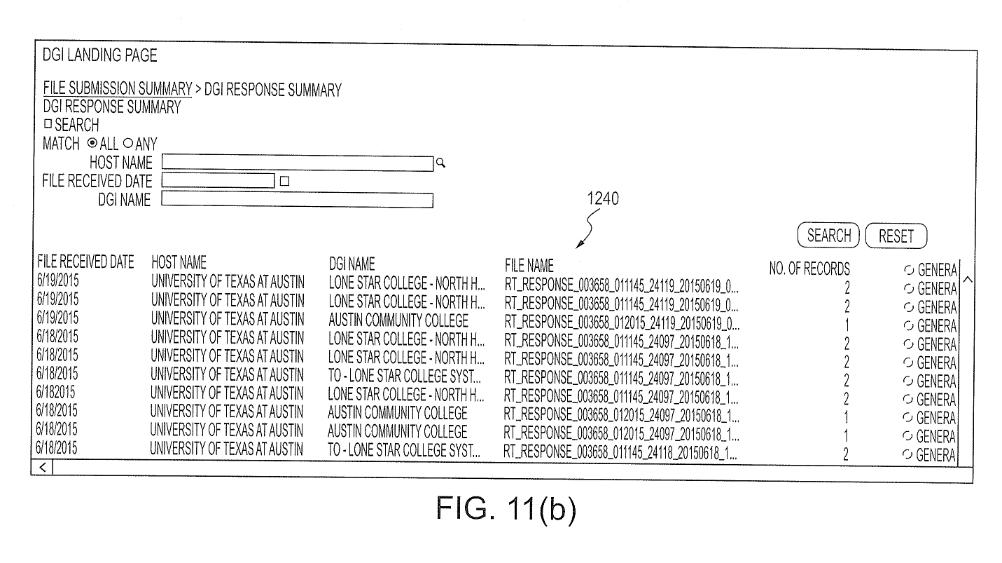

FIGS. 11(a) and 11(b) are respectively landing pages for the Host and the DGI. FIG. 11(a) is a screen shot of the file submission summary search page where the Host can query the status of files that they have sent the service provider. For failed submissions a link will be provided to review the errors (e.g. 1220) as described below.

FIG. 11(b) shows every file 1240 that the service provider has generated for the DGI to review, organized by Host name, file name and date.

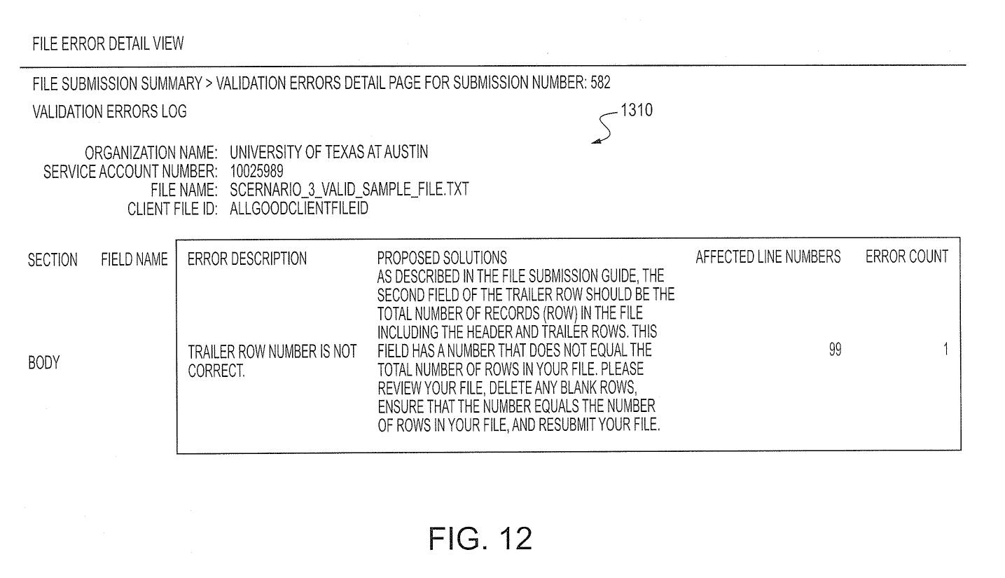

FIG. 12 shows a file error detail view screen display 1310 where the user is able to obtain detailed error information on why submitted records failed the structural validation and field level validation tests.

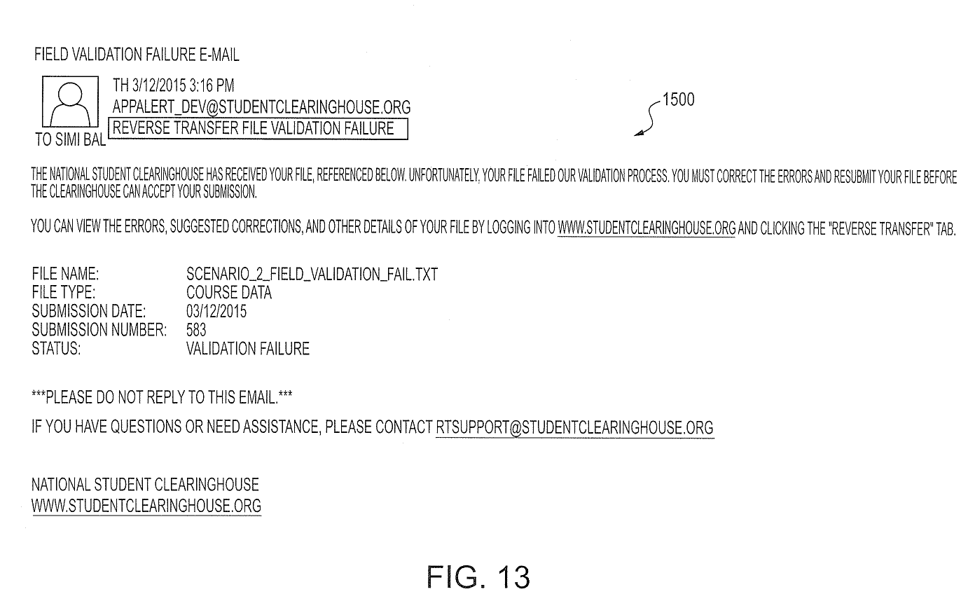

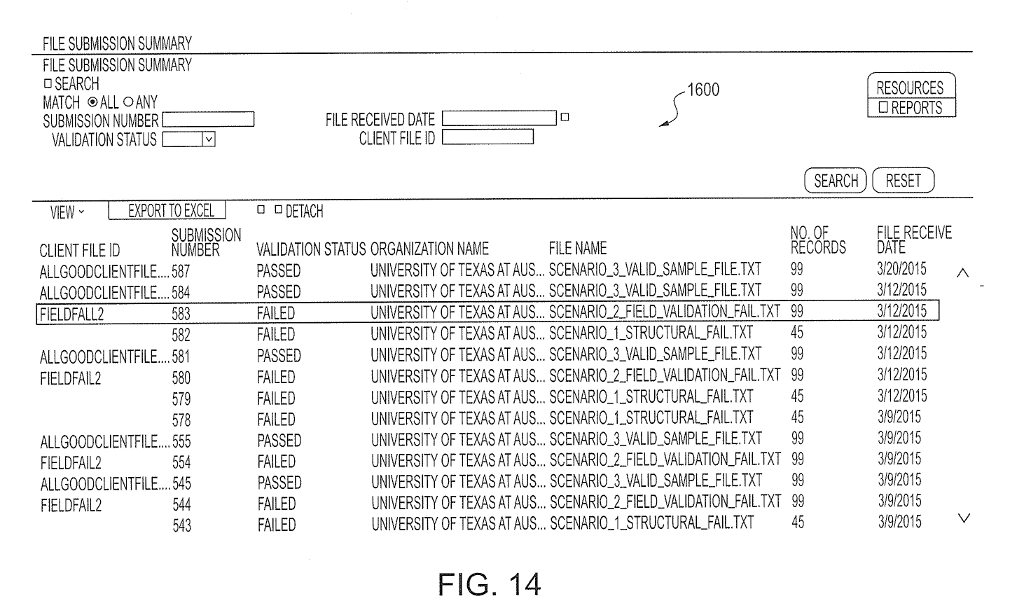

FIG. 13 is another exemplified Interface screen shot 1500 illustrating a validation failure email, where the submitted file was subject to field validation 728 as previously described in connection with FIG. 7, and the same error is shown on the file submission summary page 1600 (FIG. 14).

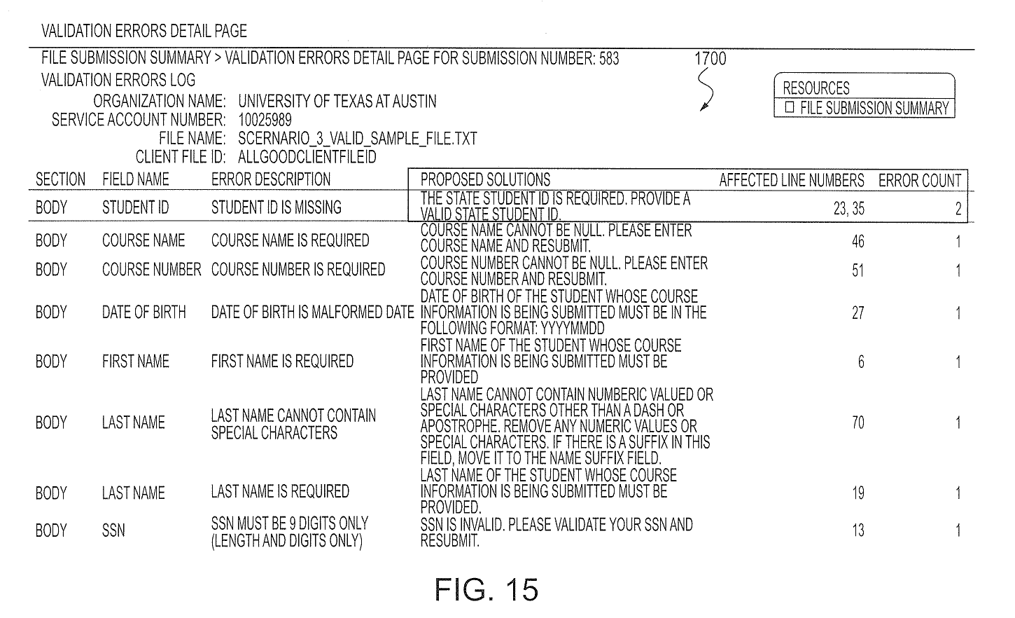

Similarly, FIG. 15 shows the field validation errors detail page 1700 which specifies the entry errors for each record.

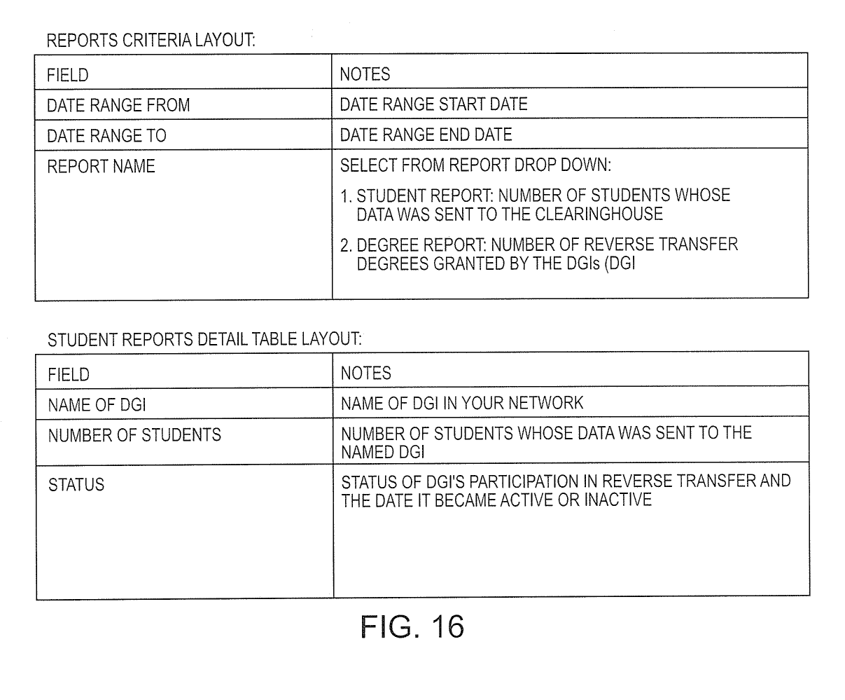

FIG. 16 illustrates a report format 22 (FIG. 1) that is provided to the Host 4 from the service provider 10 data warehouse. The Host will be provided with two types of reports: the Student Report 1800 whose data was sent to the Service Provider and the degree reports 1900 which reports on the number of reverse transfer degrees granted by the DGI's in a network.

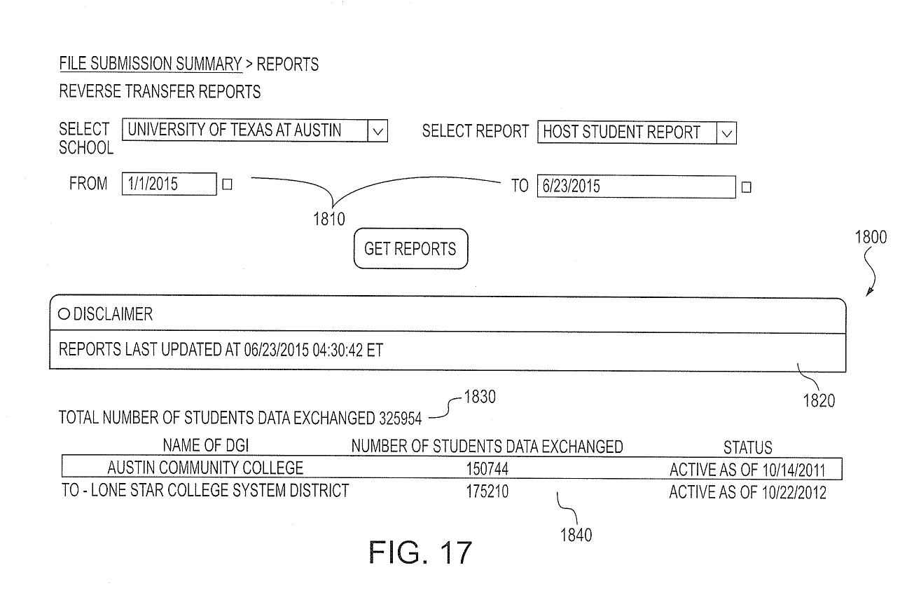

FIG. 17 is a screen shot of the Host student report 1800. Specifically, the RT report totals for a selected range of dates 1810. The report includes the last update data 1820, the total number of students data exchanged 1830 and the name of the DGI, and number of RT students from each DGI 1840.

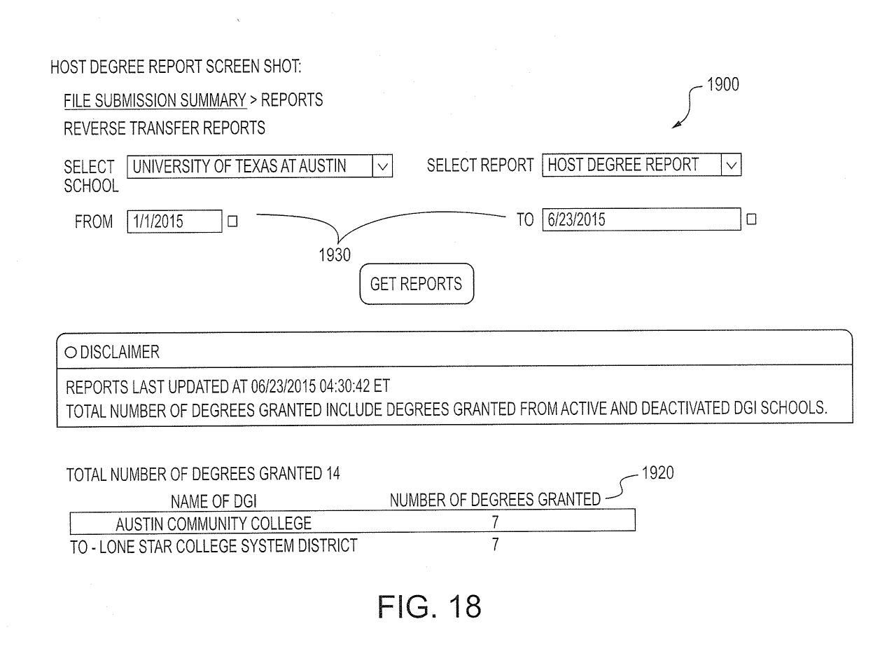

FIG. 18 shows a similarly formatted Host degree report 1900 as shown in FIG. 15, illustrating the number of degrees granted for each DGI 1920 for a selected time period or range 1930.

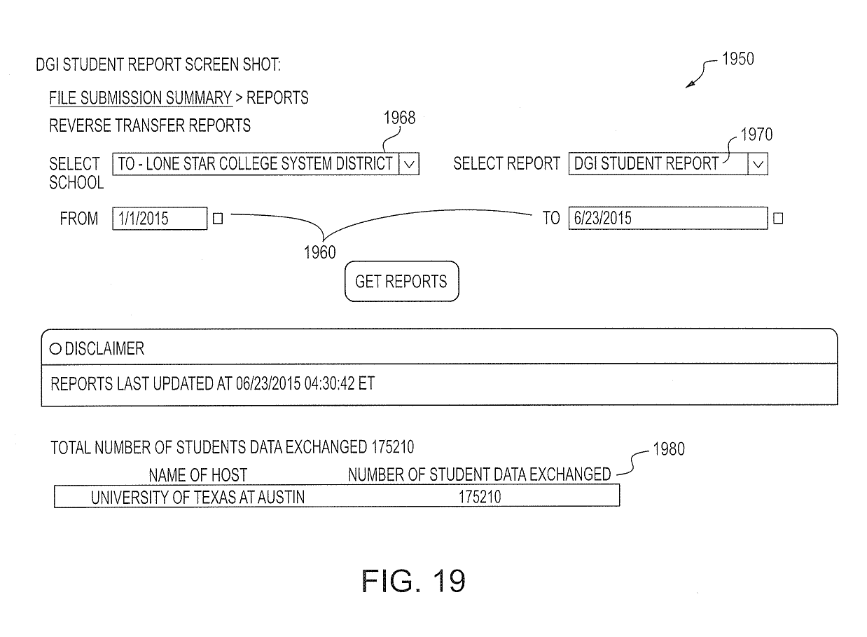

FIG. 19 shows a screen shot of the formatted DGI report 1950. As shown, the report can cover a date range 1960 for a selected DGI 1968. The user can select from two types of DGI reports in drop down menu 1970: a student report which provides the number of students whose data was sent to the requesting DGI institution, and a degree report which provides information on the number of degrees granted by the requesting DGI. In this instance, the student report was selected in 1970, which shown below 1980 for the Host school (University of Texas at Austin).

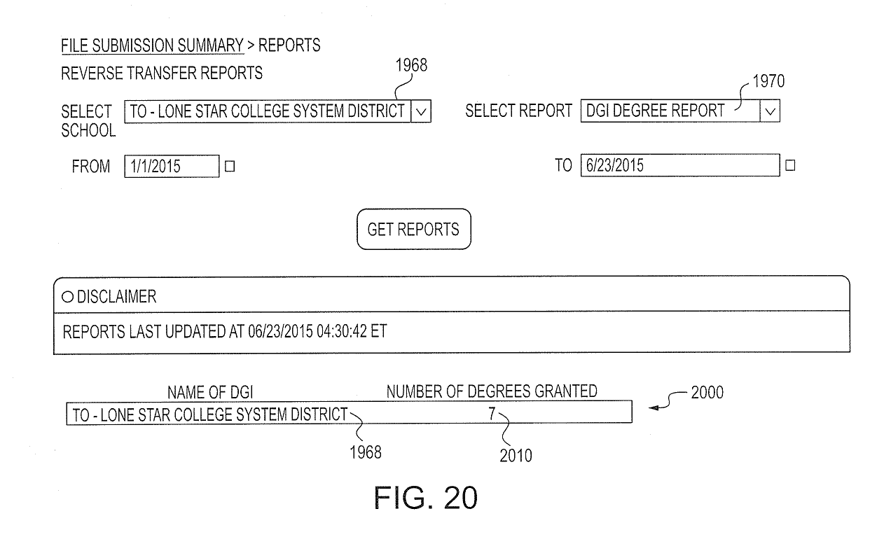

FIG. 20 is a screen shot of the formatted DGI degree report 2000, once this report format has been selected from drop down menu 1970. As shown, the number of degrees 2010 sent to the service provider by the selected DGI school 1968 is shown.

While only certain features of the invention have been illustrated and described herein, many modifications, substitutions, changes or equivalents will now occur to those skilled in the art. It is therefore to be understood that the appended claims are intended to cover all such modifications and changes that fall within the true spirit of the invention.

What is claimed as new and desired to be protected by Letters Patent of the United States is:

1. A reverse transfer system, comprising:
a host school server system,
a degree granting institution server,
a reverse transfer application server,
a secure file transfer protocol server; and
a service organization core processor; wherein a plurality of host schools provide updated course and attendance data to the file transfer protocol server which in turn merges such information in the service transfer application server with degree data provided by the degree granting institution in order to designate a degree on a student that is attending the host school.

2. The reverse transfer system of claim 1 further comprising a data integrator operative unit connected to the reverse transfer application server for performing course and degree merging for the service organization core processor.

3. The reverse transfer system of claim 1 further comprising a centralized transactions database which stores reverse transaction schemas including course details provided from the reverse transfer application server and the data integrator operation unit.

4. The reverse transfer system of claim 1 wherein the reverse transfer server further comprises a staging server for storage and coordination of reverse transfer files prior to their validations.

5. The reverse transfer system of claim 1 wherein the reverse transfer application server performs validations on recorded course information received from the host institution server.

6. The reverse transfer system of claim 5, wherein the reverse transfer validations comprise a structural validation to identify gaps in the host provided file format and a field validation to check against data elements in each field of the course file.

7. The reverse transfer system of claim 6, wherein the reverse transfer application server further performs persist operations on the data following its structural and field validation operations.

8. The reverse transfer system of claim 7, wherein the persist operations comprise persisting into a staging table both data and error information generated from the validation operation, transferring data from staging table both data and to detail tables to enable preparation of academic records for a data warehouse, and moving the validated and serviced records into the data warehouse making them available for processing by the degree granting institution server.

9. The reverse transfer system of claim 8, wherein the reverse transfer server matches the validated student course data with the provided student record data in order to confirm that the student data is without error.

10. The reverse transfer system of claim 1, further comprising a data warehouse which completes academic records dataflow, wherein such dataflow are then supplied to a separate academic record datamart.
